(19) United States
(12) Patent Application Publication
(10) Pub. No.: US 2006/0034509 A1
(43) Pub. Date: Feb. 16, 2006

(54) Color remapping

(76) Inventors: Ning Lu, Mountain View, CA (US); Jemm Liang, Sunnyvale, CA (US)

Correspondence Address: PERKINS COIE LLP, P.O. BOX 2168, MENLO PARK, CA, 94026, US

(21) Appl. No.: 10/943,539

(22) Filed: Sep. 17, 2004

Related U.S. Application Data
(60) Provisional application No. 60/602,085, filed on Aug. 16, 2004.

(51) Int. Cl. G06K 9/00

(52) U.S. Cl. 382/167

(57) ABSTRACT

A method and apparatus for gamut color remapping and compensation is provided. In one embodiment, the invention is a method. The method includes receiving input image data. The method further includes determining relationships between the input image data and known correction values. The method also includes interpolating corrections to the image data input based on the known correction values. The method further includes applying interpolated corrections to the input image data to produce normalized image data. In another embodiment, the invention is a method. The method includes measuring color distortion for a video component. The method also includes determining transforms for a set of known correction data points for the video component. The method further includes storing parameters of transforms for the set of known correction data points for the video component.

### CROSS-REFERENCE TO RELATED APPLICATION

This application claims the benefit of U.S. Provisional Patent Application No. 60/602,085 filed on Aug. 16, 2004, which is incorporated herein by reference in its entirety.

### TECHNICAL FIELD

This invention relates generally to adjusting for variations in video/image components and more specifically to adjusting gamut color values for digital images to account for performance variations in image input and image output components.

### BACKGROUND

Image data may be captured and then displayed by a variety of components. For example, scanners, still cameras, video cameras, and other input devices are available. At the other end of the process, displays vary from small cellular telephone displays through PDA and computer displays to large format video screens. Each of these devices may have changes in capabilities over time. Similarly, other input and output devices may be available. For example, color printers can have significant variations.

Output devices tend to have some colors bleed into others and some colors wear out. Additionally, manufacturing tolerances can mean that some displays never have a full range of certain colors available. Printers, in particular, can have changes in output quality due to print supply variations (ink/toner supply), manufacturing tolerances, and normal wear of components. Similarly, input devices may have some sensor elements drift out of calibration or fail to meet optimal operational tolerances at the time of manufacture. When devices do not meet specifications or tolerances, this presently results in devices being discarded rather than in sales of such devices. As a result, it may be useful to find a way to correct for real-world variations in image technology.

### BRIEF DESCRIPTION OF THE DRAWINGS

The patent or application file contains at least one drawing executed in color. Copies of this patent or patent application publication with color drawings will be provided by the Office upon request and payment of the necessary fee.

The present invention is illustrated by way of example, and not by way of limitation, in the figures of the accompanying drawings, in which like reference numerals refer to similar elements and in which:

FIG. 1 illustrates an embodiment of a process of using image data with a display.

FIG. 2 illustrates an embodiment of a color remapping procedure.

FIG. 3 illustrates an embodiment of a color cube in a color space.

FIG. 4 illustrates an embodiment of a paritioned color cube.

FIG. 5 illustrates an embodiment of a process of remapping image data for more accurate video presentation.

FIG. 6 illustrates an alternate embodiment of a process of remapping image data for more accurate video presentation.

FIG. 7 illustrates an embodiment of a process of determining remap parameters and remapping data.

FIG. 8a illustrates an embodiment of a system for remapping incoming image data.

FIG. 8b illustrates an embodiment of a system for remapping outgoing image data.

FIG. 9 illustrates an alternate embodiment of a process of remapping incoming image data.

FIG. 10 illustrates an alternate embodiment of a process of remapping outgoing image data.

FIG. 11 illustrates an embodiment of a process of capturing parameters for image remapping.

FIG. 12 illustrates an alternate embodiment of a process of capturing parameters for image remapping.

FIG. 13 illustrates an embodiment of a machine which may be used with the methods described.

FIG. 14 illustrates an embodiment of a network which may be used with the methods described.

FIG. 15 illustrates an embodiment of a system which may be used with the methods described.

### SUMMARY

A method and apparatus for gamut color remapping and compensation is provided. In one embodiment, the invention is a method. The method includes receiving input image data. The method further includes determining relationships between the input image data and known correction values. The method also includes interpolating corrections to the image data input based on the known correction values. The method further includes applying interpolated corrections to the input image data to produce normalized image data.

In another embodiment, the invention is a method. The method includes measuring color distortion for an image component. The method also includes determining transforms for a set of known correction data points for the image component. The method further includes storing parameters of transforms for the set of known correction data points for the image component.

In still another embodiment, the invention is a method. The method includes receiving standard image data. The method also includes determining relationships between the standard image data and known correction values. The method further includes interpolating corrections to the standard image data based on the known correction values. The method also includes applying interpolated corrections to the standard image data to produce output image data.

### DETAILED DESCRIPTION

The following description sets forth numerous specific details to provide a thorough understanding of the present invention. It will be apparent to one skilled in the art that the present invention can be practiced without one or more of the specific details, or with other methods, components, materials, etc. In other instances, well-known structures and operations are not shown or described in detail to avoid unnecessarily obscuring aspects of various embodiments of the present invention.

A method and apparatus for color remapping is provided. In one embodiment, the invention is a method. The method includes receiving input image data. The method further includes determining relationships between the input image data and known correction values. The method also includes interpolating corrections to the image data input based on the known correction values. The method further includes applying interpolated corrections to the input image data to produce normalized image data.

In another embodiment, the invention is a method. The method includes measuring color distortion for an image component. The method also includes determining transforms for a set of known correction data points for the image component. The method further includes storing parameters of transforms for the set of known correction data points for the image component.

In still another embodiment, the invention is a method. The method includes receiving standard image data. The method also includes determining relationships between the standard image data and known correction values. The method further includes interpolating corrections to the standard image data based on the known correction values. The method also includes applying interpolated corrections to the standard image data to produce output image data.

It is common to see color shifting and fading among different display devices even if they are made in the same brand and bought at the same time. Manufacturing tolerances and differences in change of components over time both result in unpredictable changes to color devices. Instead of physically readjusting display color (which is not only expensive, but also often impossible) a method of providing a corrective remapping before supplying data to the display devices can be useful. Similarly, a method of correcting data from image input devices may have benefits.

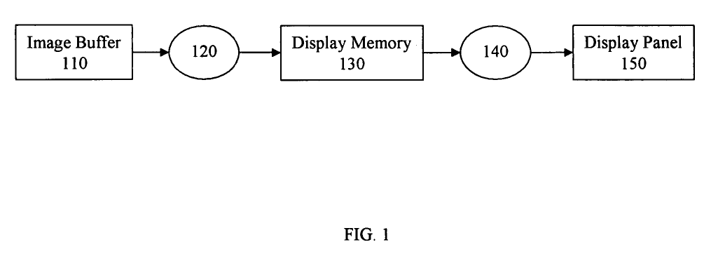

As shown in FIG. 1, the color remapping component is a functional module which can operate right before display, either within the display driver applying to display memory as in module 120, or before writing to display memory as in module 140. Thus, image buffer 110, display memory 130 and display panel 150 can each be well-known components. Image buffer 110 may be a typical frame buffer, for example. Display memory 130 may be a typical video/image memory, for example. Display panel 150 may be a typical monitor or display for example. Module 120, in one embodiment, is a remapping module which transforms output values when the values are transferred from image buffer 110 to display memory 130. Module 140, in an alternate embodiment, is a remapping module which transforms output values when the values are transferred from display memory 130 to display panel 150.

In one embodiment, the process uses a set of known color values and known corrections for the known color values. When an actual output value is presented, the output value is compared to the known color values, and a correction for the output value is interpolated from the known corrections for the known color values. The interpolation may involve simple linear scaling, or more complex operations.

Assuming C is the color space, the display distortion is a function that maps each input color value to its actual color displayed. Denote A:C [symbol] C,c [symbol] Δ(c)
the display distortion function. Then, the goal is to find a correction remapping function:
p:C C,c p(c),
such that, the combined result is very close to the original color, i.e. Δ(p(c))≈c.

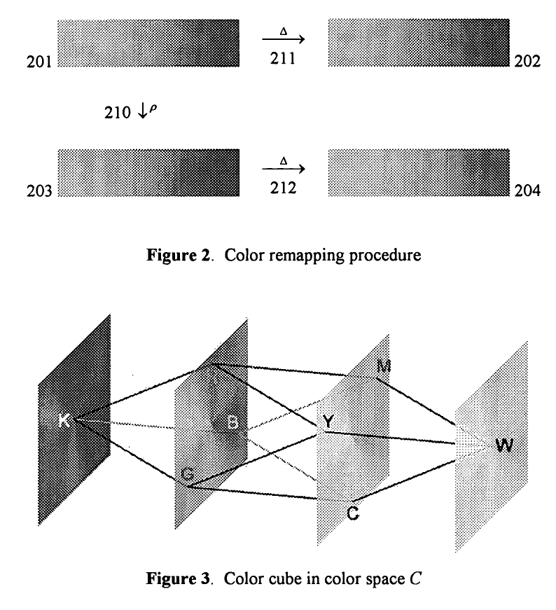

FIG. 2 shows such an example, color band 201 is the color which is supposed to be displayed, color band 202 is what actually displayed through a distorted display component that lost its red component, color band 203 is a corrected color band that will be used as the new input for display, and color band 204 is the corrected color displayed by the distorted display component. The map 210 is a color remapping, and both maps 211 and 212 are the same distorted display function (the function effectively applied by the display due to its distortion).

Comparing 204 and 202 against 201 illustrates the level of color fidelity regained. Unfortunately, certain colors may be permanently lost when they simply pass out of the display range of the given device, thus leading to truncation.

Since all human organs are subjective, including our eyes. Truncation is often not the best choice. Composing a gamma filter or having a weighted sum with the distorted one often offers better results.

In many embodiments, the most common color space uses RGB decomposition, and each color component has an integer value within the same interval [MINCOLOR, MAXCOLOR]. For simplicity of explanation, the discussion will relate to this case. Other cases can be easily generalized, most of them by applying a set of linear transformations.

Therefore, a color space C of color input values becomes an RGB cube. When mapping it to a display device, it is equivalent to embedding to the displayable color domain that is capped by the physical limitations of the device—the cube becomes distorted and truncated. As shown in FIG. 3, the 8 vertices of the cube are W, C, M, Y, R, G, B, and K (for white, cyan, magenta, yellow, red, green, blue, and black). An actual display is equivalent to how such a cube is embedded in the actual color space. FIG. 2 illustrates a perfect embedding and a distorted display which is equivalent to a distorted embedding.

Considering the integer RGB cube
C=[MINCOLOR,MAXCOLOR]×[MINCOLOR,MAXCOLOR]×[MINCOLOR,MAXCOLOR].
there exists (MAXCOLOR−MINCOLOR)³ pixels to be mapped. Theoretically, the construction of the color remapping can be very simple:

Denote Δ(C) the image of the distorted cube. For each color c in C, first find its closest color z in Δ(C), then find a representative of z:x, such that Δ(x)=z, and finally let ρ(c)=x.

However, this method is impractical—too many colors need to be detected and too many parameters need to be saved.

Practically, instead of determining and storing individual pixel remapping values, one may divide the color cube into many pieces. And within each piece, a unified description can be provided.

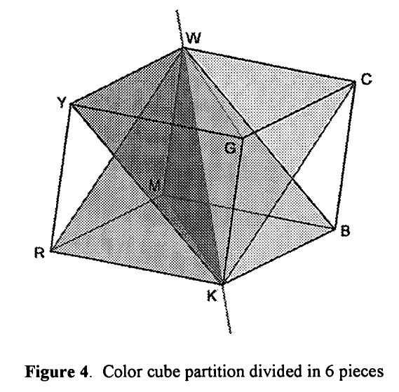

For example, one may divide the color cube into 6 pieces by cutting it along three planes: the plane containing pixels W, K, C and R, the plane containing pixels W, K, M and G, and the plane containing pixels W, K, Y and B, which is equivalent to cut the cube into six tetrahedral sections: (W,K,C,G), (W,K,C,B), (W,K,M,B), (W,K,M,R), (W,K,Y,R), and (W,K,Y,G), as shown in FIG. 4.

The following mathematical theorem helps explain why a tetrahedron is a useful shape:

Given any tetrahedron (A,B,C,D) of vertices A, B, C, and D, and given any four points 0, P, Q, and R, there is always one and only one linear map f for the tetrahedron, such that,
f(A)=O,f(B)=P,f(C)=Q, and f(D)=R.

In fact, any point X in the tetrahedron has a unique expression of
X=aA+bB+cC+dD, with a≧0,b≧0, c≧0, d≧0, and a+b+c+d=1.

Thus, all one needs to do is to define f (X)=a O+b P+c Q+d R.

In general, if a space has a tetrahedral decomposition, there is always one and only one piecewise linear function that is defined by its vertices. For the display case described above, if one defined the color correction remapping of the eight cube vertices, one may have the complete piecewise linear remapping for the whole cube.

Thus, instead of storing d³ pixel values, where d=MAXCOLOR−MINCOLOR, one needs only 24 parameters to describe the color remapping.

Although they are equivalent mathematically, there are computational advantages to choose the form for these 24 parameters to be more normalized.

Assume one already has the values for these vertices:

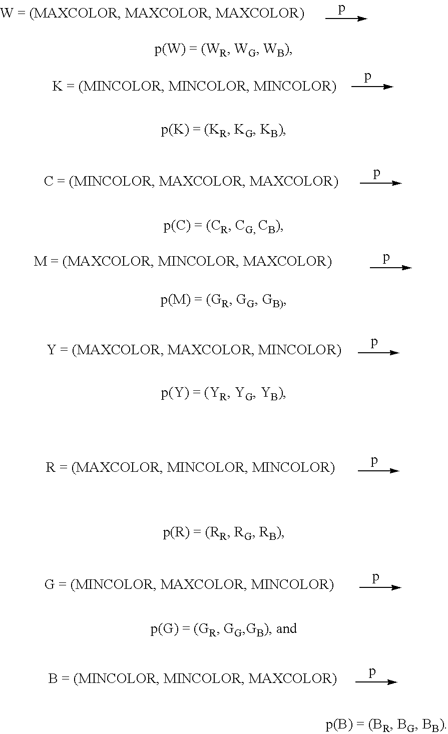

If one subtracts the black offset out from each line, and performs a normalization for each parameter above: e.g. denote
w₀=(W_{R}−K_{R})/d, w₁=(W_{G}−K_{G})/d, and w₂=(W_{B}−K_{B})/d,

Then the above list of eight colors will become:

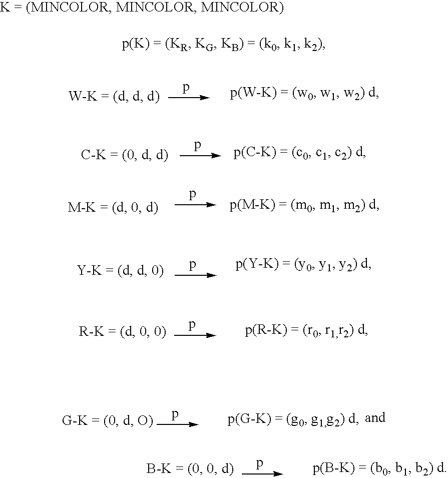

Now given any color X=K+(R, G, B), its remapping can be calculated by the following quasicode or a similar implementation:

```
        p[0]=min(R,G,B);
p[1]=min(G,B)−p[0]; p[2]=min(B,R)−p[0]; p[3]=min(R,G)−p[0];
p[4]=max(R,x[1])−p[1]; p[5]=max(G,p[2])−p[2]; p[6]=max(B,p[3])−p[3];
        for(i=0;i<3;i++)
```

| | |
|---|---|
| x[i] | = k[i] + p[0]*w[i] |
| | + p[1]*c[i] + p[2]*m[i] + p[3]*y[i] |
| | + p[4]*r[i] + p[5]*g[i] + p[6]*b[i]; |

or an equivalent process:

```
        // Tetrahedral classification:
    t = ((G>B)<<2)|((R>B)<<1)|(R>G)
// t = 0:CB, 1:MB, 3:MR, 4:CG, 6:YG, 7:YR
    t −= (t>2)+(t>4);
// t = 0:CB, 1:MB, 2:MR, 3:CG, 4:YG, 5:YR
        // Tetrahedral remapping:
for(i=0;i<3;i++)
    x[i]=k[i]+R*Rmp[t][i][0]+G*Rmp[t][i][1]+B*Rmp[t][i][2];
```

This assumes all remapping matrices Rmp [6] [3] [3] can be pre-calculated. For example for the first tetrahedron (CB),
p[0]=R, p[1]=G−R, p[6]=B−G, and all other p's are 0.

Thus,

$$\begin{matrix}x [ i ] = k [ i ] + R * w [ i ] + ( G - R ) * c [ i ] + ( B - G ) * b [ i ] \\ = k [ i ] + R * ( w [ i ] - c [ i ] ) + G ( c [ i ] - b [ i ] ) + B * b [ i ] .\end{matrix}$$

Therefore,
Rmp[0][i][0]=w[i]−c[i], Rmp[0][i][1]=c[i]−b[i], and Rmp[0][i][2]=b[i].

Consequently, the remapping tables have the following formulas:

Rmp[6][3][3]={
{w[0]−c[0],c[0]−b[0],b[0]},...,{w[2]−c[2],c[2]−b[2],b[2]},
{w[0]−m[0],m[0]−b[0],b[0]},...,{w[2]−m[2],m[2]−b[2],b[2]},
{w[0]−m[0],m[0]−r[0],r[0]},...,{w[2]−m[2],m[2]−r[2],r[2]},
{w[0]−c[0],c[0]−g[0],g[0]},...,{w[2]−c[2],c[2]−g[2],g[2]},
{w[0]−y[0],y[0]−g[0],g[0]},...,{w[2]−y[2],y[2]−g[2],g[2]},
{w[0]−y[0],y[0]−r[0],r[0]},...,{w[2]−y[2],y[2]−r[2],r[2]} };

In the discussion of the previous section, the sample remapping parameters are given by the mappings of color cube vertices, which are saturated primary colors that are often no longer recoverable. Using non-saturated colors has proven to be more effective in some embodiments.

Instead of let d=MAXCOLOR−MINCOLOR, all of these discussions are still valid for a smaller d, i.e. d=(MAXCOLOR−MINCOLOR)*q, for q=½, ⅔, ¾, etc.

Given a key color K, how does one determine its color correction? Previously, the exhausting search method was described, i.e. comparing K with everything in Δ(C), which is not efficient in practice. A different method may then be in order.

Set an initial comparison radius r to some power of 2. Start from the original color H=K. Calculate the distorted display colors of color H and its neighborhood colors of radius r, and reset the color whose distorted display is closest to the target color K to H. calculating the distorted display colors of color H until H does not change further.

If r>1, reduce the radius: r>>=1, and go back to calculating the distorted display colors of color H. Otherwise H will be the color correction of K.

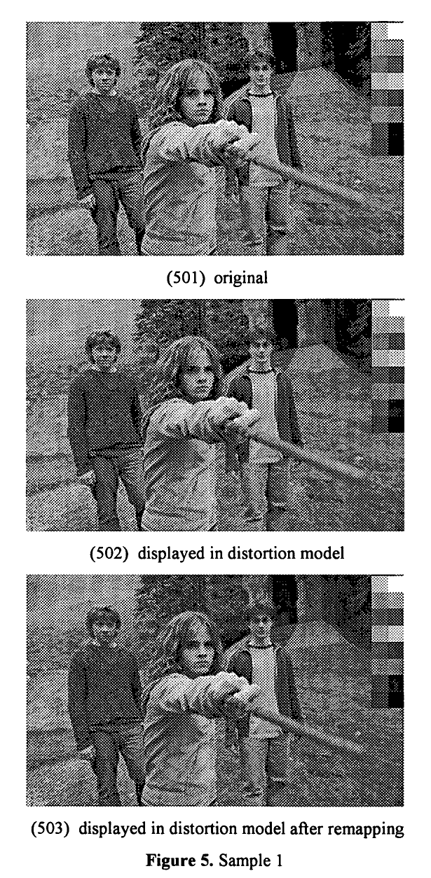

FIG. 5 illustrate an embodiment of the process, and the following quasicodes show an exact implementation of the process in one embodiment:

```
        void GetColorCorrection(int *original_color, int
*remapped_color)
        {
            int k[3],h[3],p[3],q[3],best[3];
            k[0] = h[0] = original_color[0];
            k[1] = h[1] = original_color[1];
            k[2] = h[2] = original_color[2];
            int bestd = 0x2bad2bad;
            int radius = (1<<N); // e.g. N=2
            do{
                do{
                    for(i0=−radius,i0<=radius,i0+=radius)
                    for(i1=−radius,i1<=radius,i1+=radius)
                    for(i2=−radius,i2<=radius,i2+=radius){
                        p[0]=h[0]+i0; p[1]=h[1]+i1; p[2]=h[2]+i2;
                        GetDistortedColor(p,q);
                        if((d = CompareColor(k,q))<bestd){
                        best[0] = i0; best[1] = i1;
                        best[2] = i2; bestd = d;
                        }
                    }// 3 i−s
                    if(!(best[0]|best[1]|best[2])) break;
                    h[0]+=best[0]; h[1]+=best[1]; h[2]+=best[2];
            }while(1);
            }while((radius>>=1));
            Remapped_color[0] = h[0];
            Remapped_color[1] = h[1];
            Remapped_color[2] = h[2];
        }
```

In the above codes, two functions are called: GetDistortedColor (p, q) and CompareColor(k,q). The function GetDistortedColor is determined by the actual color distortion. And the function CompareColor governs the flavors of color remapping.

The straightforward implementation of the function CompareColor is the sum of squares of differences, or the sum of absolute differences. A sophisticated implementation may often give more emphasis and weight on color fidelities. The following quasicode shows such a more complex implementation in one embodiment:

```
int CompareColor(int *k, int *q)
{
    int yk = k[0]+k[1]+k[2], yq = q[0]+q[1]+q[2];
    int uk = (k[1]−k[0])*5, uq = (q[1]−q[0])*5;
    int vk = (k[1]−k[2])*4, vq = (q[1]−q[2])*4;
    uk = abs( uq*yk−uk*yq );
    vk = abs( vq*yk−vk*yq );
    yk = (yk−yq) * (yk−yq);
    return (yk+uk+vk);
}
```

### EXAMPLES

Here two examples in various embodiments are illustrated:

### Example 1

This is typical in reality. There are some color shifts and reductions: red deteriorates and blue expands into other colors.

Mathematically, it is modeled with:
(r,g,b)→(0.8r+0.1g+0.1b,0.9g+0.1b,0.7b+0.23M),
where M is the maximum color intensity value.

FIG. 5 shows the result: 501 is the original image that was supposed to be displayed, 502 is the distorted image actually displayed without correction, and 503 is the image displayed after doing correction prior to sending data to the same distorted device.

### Example 2

This is a non-linear case. In this case, the process is applied in one embodiment to some very irregular, non-linear distortions. In fact, a very nasty transformation was chosen:
(r,g,b)→(r+0.2*b*r*(1−r),0.9*g+0.1*r,0.9*b−0.1*g*b).

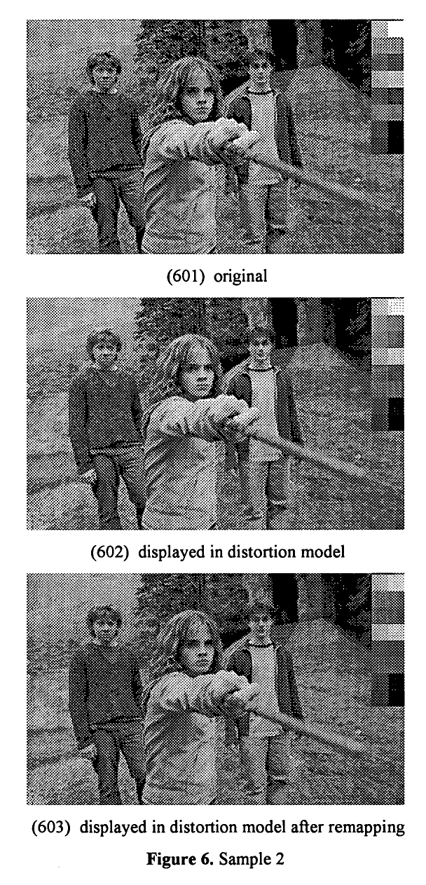

Furthermore, the assumption is made that the distortion is obtained by applying the above transformation twice (thus, leading to more irregularity). FIG. 6 show the result. Again, 601 is the original image that is suppose to be displayed, 602 is the distorted image actually displayed without correction, and 603 is the image displayed after doing correction prior to sending data to the same distorted device. The improvement is apparent upon inspection.

### ADDITIONAL EMBODIMENTS

While the invention has been described with respect to its theoretical underpinnings, specific examples, and related components, other embodiments may also be used to achieve the desired results of the present invention. For example, various processes may be used to extract parameters for remapping and for application of those parameters. Similarly, different systems may be utilized to implement remapping functions.

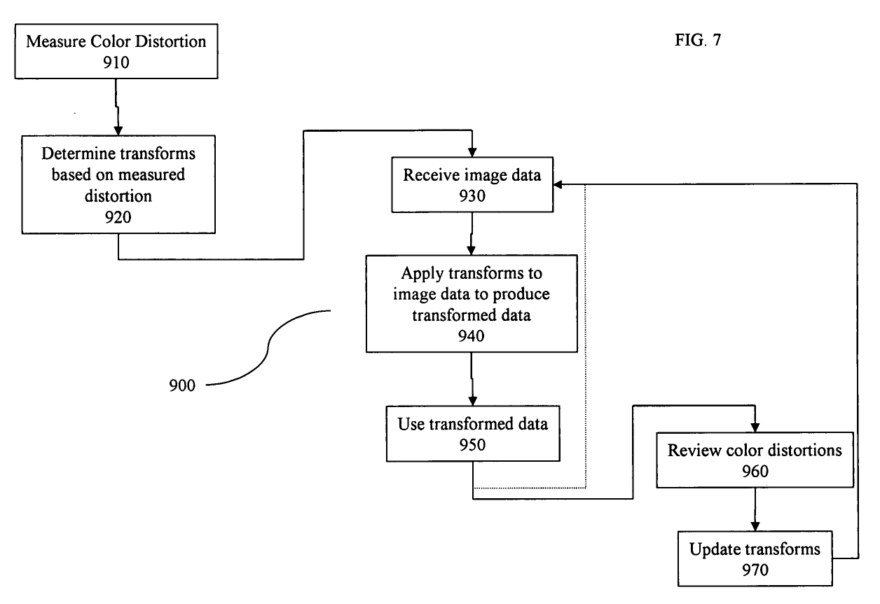

FIG. 7 illustrates an embodiment of a process of determining remap parameters and remapping data. In some embodiments of process 900, Remapping parameters may be determined by measuring color distortion and determining transforms based on the measured distortion. Remapping image data may then occur by receiving the data, applying the transforms to the data, and using the resulting transformed data. During use of a component, remapping parameters may be updated by reviewing color distortions, and updating the transforms responsive to this review.

The process of FIG. 7, and all processes described in this document, may be implemented as a set of modules, which may be used or arranged in a serial or parallel fashion, and may be rearranged within the spirit and scope of the present invention. At module 910, color distortion of the device is measured, with particular attention to the preset distortion parameters such as those mentioned previously. At module 920, transformation parameters are determined based on the measured distortion, such as by determining a set of parameters for linear mapping of the eight defined color values mentioned previously.

With the parameters determined, image data may then be remapped. At module 930, image data is received for remapping. At module 940, the transforms and parameters determined in module 920 (and potentially later updated) are applied to the image data to produce transformed data. At module 950, the transformed data is used, such as through presentation to a display component. The process may then return to module 930 with the receipt of more image data.

Alternatively, at module 960, color distortions of the video component may be reviewed. This allows for compensation for additional changes in video component performance over time. At module 970, the parameters for the transforms are updated, allowing for adaptation to additional changes. The process may then return to module 930 for additional processing of image data.

The processes described herein may be used for both image input and image output. For the most part, descriptions in this document relate to correcting image output by adjusting image data prior to display such that the display's inherent distortions produce a desirable image display. However, a similar process may be applied to image input components, such as cameras, imagerecorders, and scanners for example.

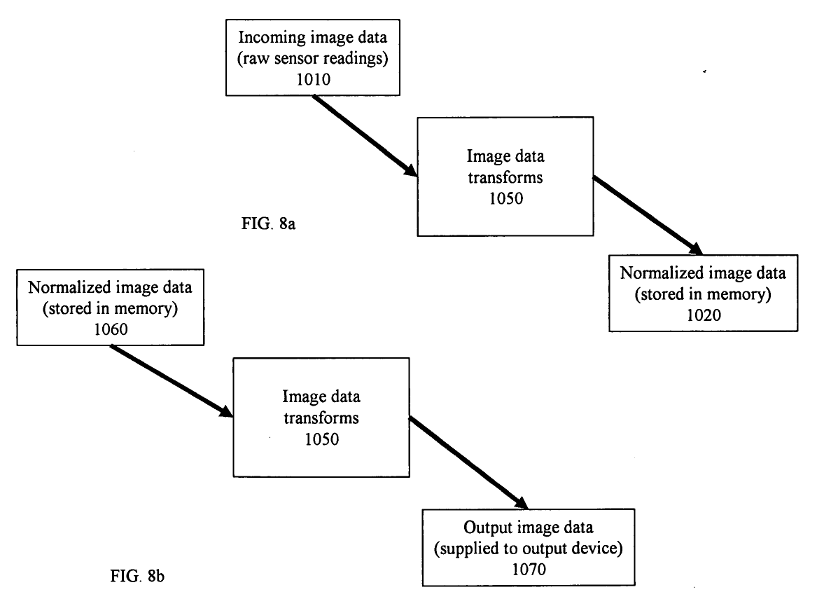

FIG. 8a illustrates an embodiment of a system for remapping incoming image data. Incoming image data is transformed using predetermined parameters specific to the image input component, and normalized or corrected image data is stored or passed on for use by a system. Incoming image data 1010 is provided to an image data transform module 1050. Data 1010 may be data directly from a sensor (such as output of a CCD for example). Alternatively, data 1010 may be data stored by an image input component which is to be cleaned up before further processing occurs. Image data transform module 1050, using parameters appropriate for the sensing component, produces image data 1020, which may be normalized or corrected image data. Preferably, image data 1020, used by a display device with proper color function (no distortion) would display an image essentially identical to the image captured by the image component.

Similarly, as previously described, a system may be used to produce desirable image output. FIG. 8b illustrates an embodiment of a system for remapping outgoing image data. Image data from memory is transformed using predetermined parameters and the transformed image data is then provided to an output device.

Normalized or corrected image data 1060 may come from memory or some other source of data. Preferably, data 1060, displayed on an undistorted display device, would replicate the image originally captured. Moreover, data 1060 may be data which has been processed by a video controller, or it may be graphics data which has not undergone device-specific video processing. Image data transform module 1050 uses predetermined parameters to transform data 1060 into output image data 1070, which may be supplied to a video device, for example. Preferably, data 1070, when displayed on the video device for which it has been transformed, will replicate the image originally captured, within the performance limits of the video device.

As mentioned previously, transformation may occur for the purpose of processing input data (such as from cameras and/or scanners for example) and processing output data (such as for monitors or displays for example). Potentially, the same transformation module or transformation process can be applied in both instances. Such a transformation involves manipulation of values, which may be represented as accumulations or combinations of electrical charge for example. Thus, such as transformation may occur at various points in the process of capturing, storing, retrieving and displaying image data, and transformation may occur more than once in such a process. However, such transformation may be expected to be device specific, either transforming device-specific input data into corrected data based on device parameters, or transforming corrected data into device-specific output data using device parameters.

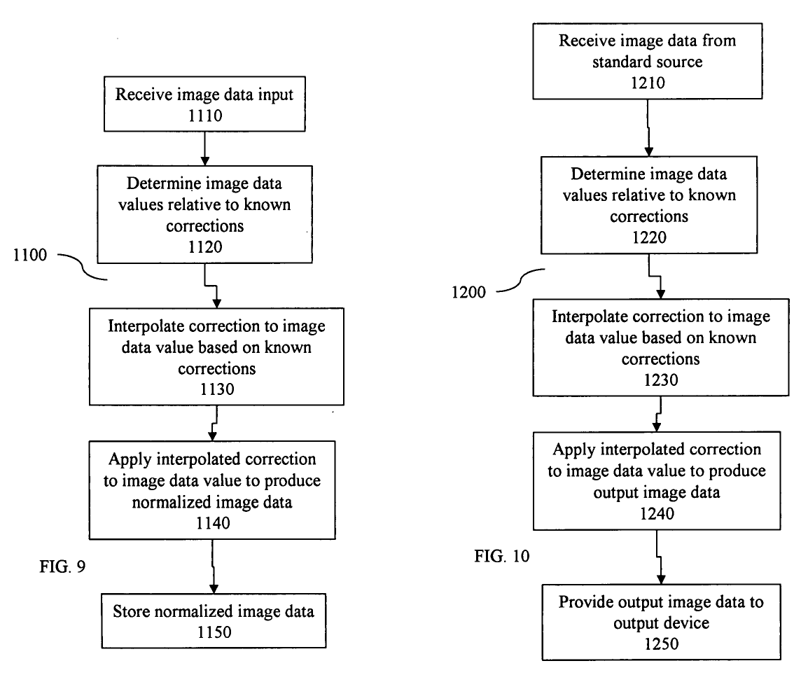

With reference to processing image input data, other embodiments of processes may be available. FIG. 9 illustrates an alternate embodiment of a process of remapping incoming image data. In some embodiments of process 1100, Image data is received and is compared to known color values with known corrections. The known corrections are those for the input device from which the image data came. Responsive to this comparison, a correction for the image data is interpolated from the known corrections. The correction for the image data is then applied to the image data resulting in normalized image data which is then stored or used.

As with other processes, various process modules are provided. At module 1110, image data is received. At module 1120, the image data is compared to color values with known corrections to determine which color values have the most useful corrections. For example, using the tetrahedrons discussed previously, a determination of which tetrahedron contains the image data may be made.

At module 1130, a correction for the image data is interpolated based on the known correction values for the appropriate colors. Module 1130 may involve looking up a function associated with a particular tetrahedron, and/or calculating distances from various colors within a color cube for example. At module 1140, the interpolated correction is applied to the image data to produce normalized or corrected image data. At module 1150, the corrected or normalized image data is then stored or otherwise used by a surrounding system for example.

Similarly, output image data may be processed in various ways. FIG. 10 illustrates an alternate embodiment of a process of remapping outgoing image data. In some embodiments of process 1200, Image data is received and is compared to known color values with known corrections for the output component in question. Responsive to this comparison, a correction for the image data is interpolated from the known corrections. The correction for the image data is applied to the image data resulting in normalized image data which is then provided for output or stored.

At module 1210, image data is received. This image data may be normalized or corrected image data, or entirely unprocessed image data. At module 1220, the image data is compared to color values with known corrections to determine which color values have the most useful corrections. For example, using the tetrahedrons discussed previously, a determination of which tetrahedron contains the image data may be made. The corrections are known corrections for the output device in question.

At module 1230, a correction for the image data is interpolated based on the known correction values for the colors identified at module 1220. Module 1230 may involve looking up a function associated with a particular tetrahedron, and/or calculating distances from various colors within a color cube for example. At module 1240, the interpolated correction is applied to the image data to produce image data tailored to the output device in question. At module 1250, the tailored output image data is then stored or provided to the output device for example.

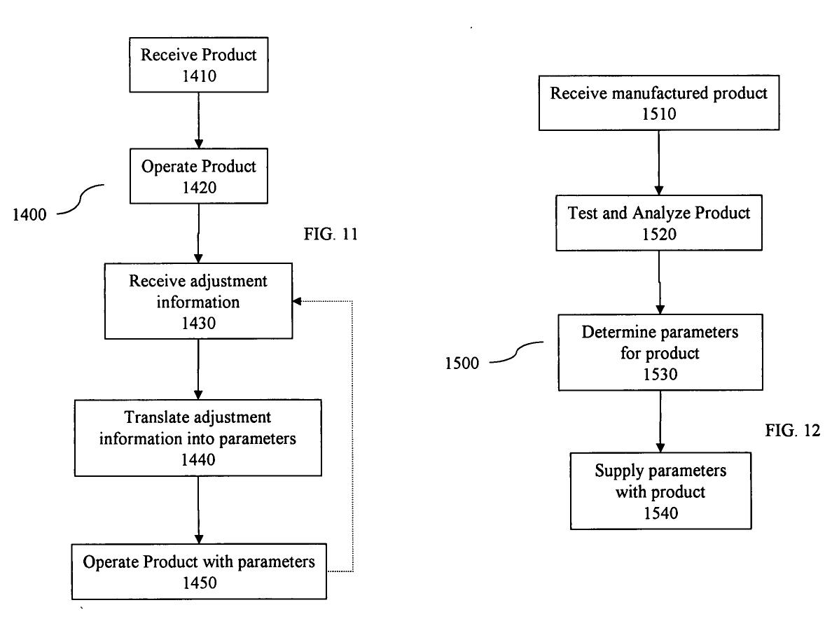

While producing tailored or corrected output and input data is the goal, determining the proper parameters for production of such data is also important. FIG. 11 illustrates an embodiment of a process of capturing parameters for image remapping. Process 1400, in some embodiments, includes receiving a product, operating the product, receiving adjustment information for the product, translating the adjustment information into image adjustment parameters, and operating the product with these image adjustment parameters. In some embodiments, process 1400 is related to user adjustment of a device such as a monitor or printer (output devices) or a camera (input devices) for example.

At module 1410, a product is received, such as a monitor or camera for example. At module 1420, the product is operated, such as by turning it on and initiating either an initial calibration mode or a user calibration mode. At module 1430, adjustment information is received, such as by receiving indications from a user of whether hue or saturation needs to change for various colors associated with the product. At module 1440, the adjustment information is translated into parameters which may be used with processes such as those of FIGS. 9 and 10 for example. At module 1450, the product is operated using the parameters of module 1440, preferably with color corrected in accordance with the information received at module 1430. The process may be repeated as appropriate, by returning to module 1430 for receipt of further performance feedback information.

Other methods of obtaining parameters may also be useful. FIG. 12 illustrates an alternate embodiment of a process of capturing parameters for image remapping. Process 1500, in some embodiments, includes receiving a product, testing and analyzing the product, determining correction parameters for the product, and supplying those parameters with the product. Such a process may be useful in a manufacturing situation for example.

At module 1510, a manufactured product is received for test and analysis. At module 1520, the product is tested and analyzed to determine variations between the product's gamut color and a standard or desired gamut color. The product may be representative of a manufacturing lot of products, all of which may be expected to have similar performance or properties. In some embodiments, several products of a manufacturing lot may be tested, potentially resulting in a spectrum of results. Alternatively, all products may be tested individually.

At module 1530, results of testing and analysis are used to determine parameters which may be used to correct color input or color output of the device in question. If several products within a manufacturing lot are tested, an averaging or statistical compilation of data from all of the products may be useful. At module 1540, the parameters are supplied with the product. This may be accomplished by programming those parameters into the product (and other products within its manufacturing lot) or by other means such as a specification sheet to be used when preparing the product for use.

The combination of processes 1400 and 1500 may be useful as a two stage process which can account for both manufacturing variations and later variations over time. Manufacturing level changes may be introduced on a lot-basis or individual product basis using process 1500, supplying a first set of parameters for correction which may be used in processes such as processes 900, 1100 and 1200 for example. Individual device changes may then be introduced using process 1400, either on an initial basis (e.g. installation) or a periodic basis (e.g. periodic maintenance).

Process 1400 may produce a second set of parameters for correction which may be used in processes such as processes 900, 1100 and 1200 for example. Thus, the second set of parameters may be used to further correct data after correction based on the first set of parameters, or to modify the first set of parameters. That is, the second set of parameters may be used in a serial fashion after the first set of parameters, or the second set of parameters may be combined with the first set of parameters. Alternatively, the process 1400 may effectively update the first set of parameters (replacing parameters from process 1500 for example), resulting in a single set of parameters used by processes 900, 1100 and 1200 for example.

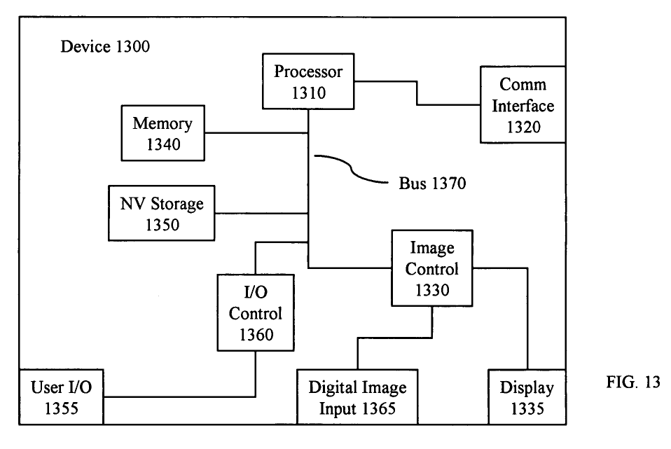

FIG. 13 illustrates an embodiment of a machine which may be used with the methods described. Device 1300 may be a cellular telephone or digital camera, for example. Device 1300 includes a processor, memory, interfaces, controllers for interfaces, and an internal bus for communication. Processor 1310 may be a microprocessor or digital signal process for example. Coupled to processor 1310 is communications interface 1320, which may be an RF communications interface, a telephone modem, or other communications interface for example, and may allow for various forms of communications with a network or other machines, for example.

Also coupled to processor 1310 is bus 1370, which in some embodiments is a point-to-point bus and in other embodiments is implemented in other topologies allowing for more or less communication between components for example. Coupled to processor 1310 is also memory 1340 and non-volatile storage 1350, both through bus 1370 in the illustrated embodiment. Memory 1340 may be of various forms, such as the memory types described below. Similarly, non-volatile storage 1350 may be of various forms, such as forms of non-volatile storage mentioned below. Both memory 1340 and non-volatile storage 1350 may encode parameters for use in correcting image data. Furthermore, memory 1340 may store image data, in either corrected or uncorrected form.

Additionally, coupled to processor 1310 is I/O control 1360, along with user I/O interface 1355, both of which may be used for input and output for a user. Furthermore, image control module 1330 is coupled to processor 1310 and to digital image input module 1365 and display 1335. One or both of module 1365 and display 1335 may be included in some embodiments. Digital image input module 1365 may include a lens and image capture sensors, for example. Similarly, display 1335 may incorporate an LCD (liquid crystal display) for example. Image control module 1330 may retrieve data from memory 1340 and non-volatile storage 1350, and may incorporate its own internal memory or non-volatile storage. In some embodiments, image control module 1330 may perform methods such as methods 900, 1100 and 1200 for example. Alternatively, such methods may be performed by digital image input module 1365 or display 1335, or by processor 1310.

System Considerations

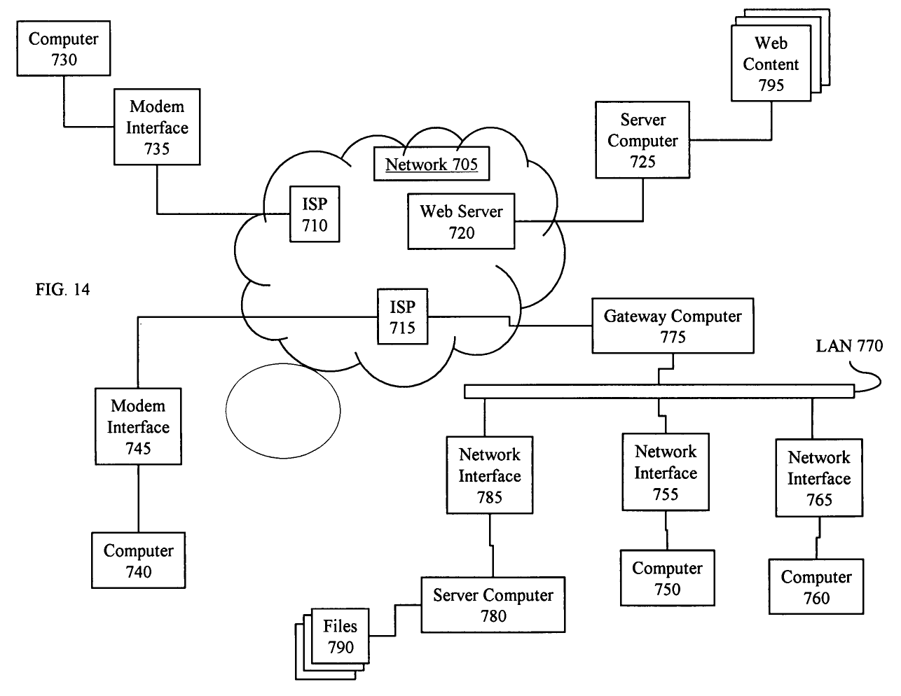

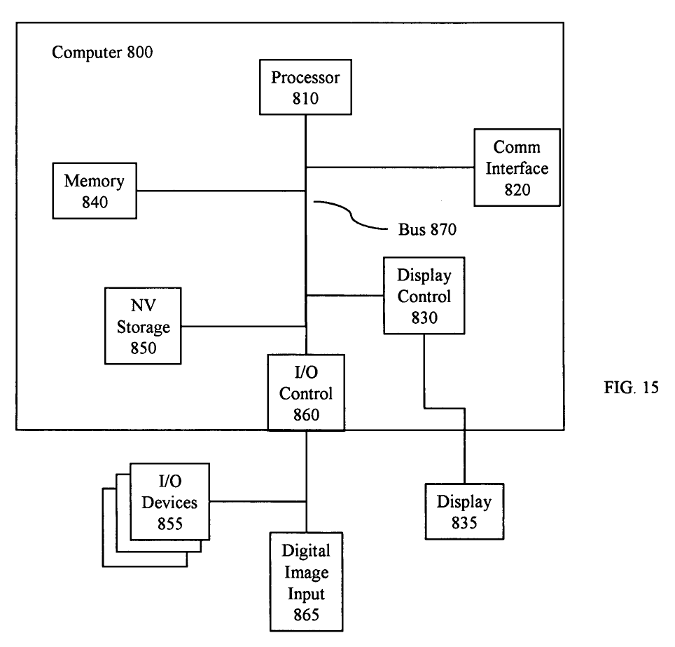

The following description of FIGS. 14-15 is intended to provide an overview of computer hardware and other operating components suitable for performing the methods of the invention described above, but is not intended to limit the applicable environments. Similarly, the computer hardware and other operating components may be suitable as part of the apparatuses of the invention described above. The invention can be practiced with other computer system configurations, including hand-held devices, multiprocessor systems, microprocessor-based or programmable consumer electronics, network PCs, minicomputers, mainframe computers, and the like. The invention can also be practiced in distributed computing environments where tasks are performed by remote processing devices that are linked through a communications network.

FIG. 14 shows several computer systems that are coupled together through a network 705, such as the Internet. The term “Internet” as used herein refers to a network of networks which uses certain protocols, such as the TCP/IP protocol, and possibly other protocols such as the hypertext transfer protocol (HTTP) for hypertext markup language (HTML) documents that make up the World Wide Web (web). The physical connections of the Internet and the protocols and communication procedures of the Internet are well known to those of skill in the art.

Access to the Internet 705 is typically provided by Internet service providers (ISP), such as the ISPs 710 and 715. Users on client systems, such as client computer systems 730, 740, 750, and 760 obtain access to the Internet through the Internet service providers, such as ISPs 710 and 715. Access to the Internet allows users of the client computer systems to exchange information, receive and send e-mails, and view documents, such as documents which have been prepared in the HTML format. These documents are often provided by web servers, such as web server 720 which is considered to be “on” the Internet. Often these web servers are provided by the ISPs, such as ISP 710, although a computer system can be set up and connected to the Internet without that system also being an ISP.

The web server 720 is typically at least one computer system which operates as a server computer system and is configured to operate with the protocols of the World Wide Web and is coupled to the Internet. Optionally, the web server 720 can be part of an ISP which provides access to the Internet for client systems. The web server 720 is shown coupled to the server computer system 725 which itself is coupled to web content 795, which can be considered a form of a media database. While two computer systems 720 and 725 are shown in FIG. 14, the web server system 720 and the server computer system 725 can be one computer system having different software components providing the web server functionality and the server functionality provided by the server computer system 725 which will be described further below.

Client computer systems 730, 740, 750, and 760 can each, with the appropriate web browsing software, view HTML pages provided by the web server 720. The ISP 710 provides Internet connectivity to the client computer system 730 through the modem interface 735 which can be considered part of the client computer system 730. The client computer system can be a personal computer system, a network computer, a Web TV system, or other such computer system.

Similarly, the ISP 715 provides Internet connectivity for client systems 740, 750, and 760, although as shown in FIG. 14, the connections are not the same for these three computer systems. Client computer system 740 is coupled through a modem interface 745 while client computer systems 750 and 760 are part of a LAN. While FIG. 14 shows the interfaces 735 and 745 as generically as a “modem,” each of these interfaces can be an analog modem, ISDN modem, cable modem, satellite transmission interface (e.g. “Direct PC”), or other interfaces for coupling a computer system to other computer systems.

Client computer systems 750 and 760 are coupled to a LAN 770 through network interfaces 755 and 765, which can be Ethernet network or other network interfaces. The LAN 770 is also coupled to a gateway computer system 775 which can provide firewall and other Internet related services for the local area network. This gateway computer system 775 is coupled to the ISP 715 to provide Internet connectivity to the client computer systems 750 and 760. The gateway computer system 775 can be a conventional server computer system. Also, the web server system 720 can be a conventional server computer system.

Alternatively, a server computer system 780 can be directly coupled to the LAN 770 through a network interface 785 to provide files 790 and other services to the clients 750, 760, without the need to connect to the Internet through the gateway system 775.

FIG. 15 shows one example of a conventional computer system that can be used as a client computer system or a server computer system or as a web server system. Such a computer system can be used to perform many of the functions of an Internet service provider, such as ISP 710. The computer system 800 interfaces to external systems through the modem or network interface 820. It will be appreciated that the modem or network interface 820 can be considered to be part of the computer system 800. This interface 820 can be an analog modem, ISDN modem, cable modem, token ring interface, satellite transmission interface (e.g. “Direct PC”), or other interfaces for coupling a computer system to other computer systems.

The computer system 800 includes a processor 810, which can be a conventional microprocessor such as an Intel Pentium microprocessor or Motorola Power PC microprocessor. Memory 840 is coupled to the processor 810 by a bus 870. Memory 840 can be dynamic random access memory (DRAM) and can also include static RAM (SRAM). The bus 870 couples the processor 810 to the memory 840, also to non-volatile storage 850, to display controller 830, and to the input/output (I/O) controller 860.

The display controller 830 controls in the conventional manner a display on a display device 835 which can be a cathode ray tube (CRT) or liquid crystal display (LCD). The input/output devices 855 can include a keyboard, disk drives, printers, a scanner, and other input and output devices, including a mouse or other pointing device. The display controller 830 and the I/O controller 860 can be implemented with conventional well known technology. A digital image input device 865 can be a digital camera which is coupled to an I/O controller 860 in order to allow images from the digital camera to be input into the computer system 800.

The non-volatile storage 850 is often a magnetic hard disk, an optical disk, or another form of storage for large amounts of data. Some of this data is often written, by a direct memory access process, into memory 840 during execution of software in the computer system 800. One of skill in the art will immediately recognize that the terms “machine-readable medium” or “computer-readable medium” includes any type of storage device that is accessible by the processor 810 and also encompasses a carrier wave that encodes a data signal.

The computer system 800 is one example of many possible computer systems which have different architectures. For example, personal computers based on an Intel microprocessor often have multiple buses, one of which can be an input/output (I/O) bus for the peripherals and one that directly connects the processor 810 and the memory 840 (often referred to as a memory bus). The buses are connected together through bridge components that perform any necessary translation due to differing bus protocols.

Network computers are another type of computer system that can be used with the present invention. Network computers do not usually include a hard disk or other mass storage, and the executable programs are loaded from a network connection into the memory 840 for execution by the processor 810. A Web TV system, which is known in the art, is also considered to be a computer system according to the present invention, but it may lack some of the features shown in FIG. 15, such as certain input or output devices. A typical computer system will usually include at least a processor, memory, and a bus coupling the memory to the processor.

In addition, the computer system 800 is controlled by operating system software which includes a file management system, such as a disk operating system, which is part of the operating system software. One example of an operating system software with its associated file management system software is the family of operating systems known as Windows® from Microsoft Corporation of Redmond, Wash., and their associated file management systems. Another example of an operating system software with its associated file management system software is the LINUX operating system and its associated file management system. The file management system is typically stored in the non-volatile storage 850 and causes the processor 810 to execute the various acts required by the operating system to input and output data and to store data in memory, including storing files on the non-volatile storage 850.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention, in some embodiments, also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from other portions of this description. In addition, the present invention is not described with reference to any particular programming language, and various embodiments may thus be implemented using a variety of programming languages.

While specific embodiments of the invention have been illustrated and described herein, it will be appreciated that various changes can be made therein without departing from the spirit and scope of the invention.

What is claimed is:

1. A method, comprising:
receiving image data input;
determining relationships between the image data input and known correction values;
interpolating corrections to the image data input based on the known correction values; and
applying interpolated corrections to the image data input to produce normalized image data.

2. The method of claim 1, wherein:
the known correction values are for a set of designated color values including white, black, red, green, blue, cyan, magenta and yellow.

3. The method of claim 1, wherein:
the image data input is received in a digital camera.

4. The method of claim 1, wherein:
the image data input is received in a digital scanner.

5. The method of claim 1, wherein:
the image data input is received in a digital video recorder.

6. An apparatus, comprising:
a processor;
a memory coupled to the processor;
a digital image input module coupled to the processor;
and wherein the processor is to:
receive image data input through the digital image module,
determine relationships between the image data input and known correction values of the memory,
interpolate corrections to the image data input based on the known correction values, and
apply interpolated corrections to the image data input to produce normalized image data.

7. The apparatus of claim 6, wherein:
the processor is further to:
store normalized image data in the memory.

8. A method, comprising:
measuring color distortion for a image component;
determining transforms for a set of known correction data points for the image component; and
storing parameters of transforms for the set of known correction data points for the image component.

9. The method of claim 8, wherein:
the known correction data points are for a set of designated color values including white, black, red, green, blue, cyan, magenta and yellow.

10. The method of claim 8, wherein:
the image component is a digital camera.

11. The method of claim 8, wherein:
the image component is a monitor.

12. The method of claim 8, wherein:
the image component is a digital scanner.

13. The method of claim 8, wherein:
the image component is a printer.

14. The method of claim 8, wherein:
the image component is a digital image recorder.

15. The method of claim 8, wherein:
the image component is a display.

16. An apparatus, comprising:
a processor;
a memory coupled to the processor;
a digital image component coupled to the processor;
and wherein the processor is to:
measure color distortion for the image component;
determine transforms for a set of known correction data points for the image component; and
store parameters of transforms for the set of known correction data points for the image component in the memory.

17. A method, comprising:
receiving standard image data;
determining relationships between the standard image data and known correction values;
interpolating corrections to the standard image data based on the known correction values; and
applying interpolated corrections to the standard image data to produce output image data.

18. The method of claim 17, wherein:
the image component is a monitor.

19. The method of claim 17, wherein:
the image component is a printer.

20. The method of claim 17, wherein:
the image component is a display.

21. The method of claim 17, wherein:
the known correction values are for a set of designated color values including white, black, red, green, blue, cyan, magenta and yellow.

22. An apparatus, comprising:
a processor;
a memory coupled to the processor;
a digital image output component coupled to the processor;
and wherein the processor is to:
receive standard image data from the memory;
determine relationships between the standard image data and known correction values;
interpolate corrections to the standard image data based on the known correction values; and
apply interpolated corrections to the standard image data to produce output image data for the digital image output component.

23. The apparatus of claim 22, wherein:
the processor is further to:
supply the output image data to the digital image output component.

24. The apparatus of claim 22, wherein:
the known correction values are for a set of designated color values including white, black, red, green, blue, cyan, magenta and yellow.

25. The apparatus of claim 22, wherein:
the digital image output component is a monitor.

26. The apparatus of claim 22, wherein:
the digital image output component is a printer.

27. The apparatus of claim 22, wherein:
the digital image output component is a display.

28. An apparatus, comprising:
means for receiving image data;
means for altering the image data based on known correction values and relationships between the known correction values and the image data; and
means for storing the image data.

29. The apparatus of claim 28, further comprising:
means for capturing the image data.

30. An apparatus, comprising:
means for receiving image data;
means for altering the image data based on known correction values and relationships between the known correction values and the image data; and
means for providing output based on the image data.
